(19) United States
(12) Patent Application Publication
(10) Pub. No.: US 2013/0141049 A1
(43) Pub. Date: Jun. 6, 2013

(54) BATTERY AND METHOD FOR OPERATING A BATTERY

(71) Applicant: Li-Tec Battery GmbH, Kamenz (DE)

(72) Inventor: Tim Schaefer, Harztor (DE)

(73) Assignee: Li-Tec Battery GmbH, Kamenz (DE)

(21) Appl. No.: 13/680,712

(22) Filed: Nov. 19, 2012

Related U.S. Application Data
(60) Provisional application No. 61/563,642, filed on Nov. 25, 2011.

(30) Foreign Application Priority Data
Nov. 25, 2011 (DE) 10 2011 119 470.7

(51) Int. Cl. H02J 7/00

(52) U.S. Cl. CPC H02J 7/0063
USPC 320/127

(57) ABSTRACT

The method for operating a battery including several electrochemical cells and a battery control unit, includes collecting operating parameter data of the battery, transmitting the operating parameter data to the battery control unit, and determining whether a predefined relationship of the collected operating parameter data with regard to predefined operating parameter values exists for the battery, and carrying out normal operation of the battery if it does. If, it has been determined that the predefined relationship with respect to the predefined operating parameter values does not exist, a query is transmitted to a decision unit as to whether an exception operation of the battery is to be carried out, and a response to the query by the decision unit is determined. The response is then transmitted to the battery control unit, and an exception operation of the battery is performed by the battery control unit depending on the response.

The invention relates to a battery and a method for operating a battery, particularly a battery designed for use in motor vehicles.

Electrochemical energy storage means, also referred to in the following as electrochemical or galvanic cells, are often produced in the form of stackable units, a plurality of which cells may be combined to produce batteries for various applications, particularly for use in electrically powered motor vehicles. The invention will be described with reference to their use in a motor vehicle, but it should also be noted that an appropriately designed electrochemical cell may also be operated in installations other than motor vehicles, for example in stationary applications.

The object underlying the present invention is to provide an improved method for operating a battery.

This object is solved with a method for operating a battery according to claim 1 and a battery according to claim 17. The dependent claims refer to advantageous embodiments of the invention.

According to a first aspect, this object is solved with a method for operating a battery comprising a plurality of electrochemical cells, particularly a battery designed for use in a motor vehicle and having a battery control unit, wherein the method includes the following steps: collecting operating parameter data of the battery, transmitting the operating parameter data to a control unit, determining whether the collected operating parameter data of the battery satisfy predefined operating conditions, and carrying out normal operation of the battery if it has been determined in the preceding step that the collected operating parameter data of the battery satisfy the predefined operating conditions, solved in that, if it is determined in the step of determining whether the collected operating parameter data of the battery satisfy predefined operating conditions, it has been determined that the collected operating parameter data of the battery do not satisfy the predefined operating conditions, the method comprises the following steps: transmitting a query to a decision unit as to whether an exception operation of the battery is to be carried out, determining a response to the query by the decision unit, transmitting the response to the battery control unit, carrying out an exception operation of the battery by the battery control unit depending on the corresponding response transmitted in the preceding step, if it has been determined by the decision unit in the preceding step to carry out an exception operation. One advantage of this configuration consists in that an exception operation of the battery can be carried out safely. A further advantage consists in that an emergency reserve function may be carried out depending on technical features of the battery, thereby enabling any compromise of the service life or safety to be avoided.

For the purposes of the present invention, an electrochemical cell is understood to be an electrochemical energy storage means, that is to say a device that is able to store energy in chemical form, deliver energy to a consumer in the form of electricity, and preferably also draw energy in the form of electricity from a charging device. Important examples of such electrochemical energy storage means are galvanic cells or fuel cells. The electrochemical cell has at least a first and a second device for storing electrically different charges, which devices are preferably constructed as an electrode arrangement, and a means for establishing an electrically operative connection between the two said devices, wherein charge carriers are moved between these two devices. The means for establishing an electrically operative connection may be understood to refer for example to an electrolyte that functions as an ion conductor.

For the purposes of the present invention, the term operating parameter data is to be understood to refer not only to a plurality of operating parameter data items, but possibly also to a single item of operating parameter data. Similarly, for the purposes of the present invention, the term operating parameter values is to be understood to refer not only to a plurality of operating parameter values, but possibly also to a single operating parameter value.

The step of carrying out an exception operation of the battery as part of the method preferably at least partly includes one of the following steps of outputting energy by the battery: discharging electrical energy from the battery with a pulse method, discharging electrical energy from the battery with a lower electrical current than in normal operation, discharging electrical energy from the battery with variable voltage, or discharging electrical energy from the battery with variably diminishing voltage.

In the method, one of the predefined operating conditions preferably includes a battery voltage in a range from 1.9 V to 4.5 V, and particularly preferably 3.7 V. In this method, preferably at least one electrode of the electrochemical energy storage means, particularly preferably at least a cathode, includes a compound with formula LiMPO₄, wherein M is at least one transition metal cation from the first row of the periodic table of elements. The transition metal cation is preferably selected from the group including Mn, Fe, Ni and Ti or a combination of these elements. The compound preferably has an olivine structure, preferably superior olivine, Fe being particularly preferred. In a further embodiment, preferably at least one electrode of the electrochemical storage means, particularly preferably at least a cathode, includes a lithium manganate, preferably LiMn₂O₄ of the spinel type, a lithium cobaltate, preferably LiCoO₂, or a lithium nickelate LiNiO₂, or a mixture of two or three of these oxides, or a lithium mixed oxide that contains manganese, cobalt and nickel. For the systems that contain lithium iron phosphate (LFP), battery voltages from 2.0 V to 3.65 V have proven particularly advantageous as predefined operating conditions. For the systems that contain lithium-cobalt-manganese-nickel systems (NMC), battery voltages from 2.5 V to 4.2 V have proven particularly advantageous for the predefined operating conditions.

Preferably according to the invention, a separator is used that is poorly ion conductive, or non-conductive, and which is made from an at least partially substance-permeable carrier. At least one side of the carrier is preferably coated with an inorganic material. The at least partially substance-permeable carrier is preferably made from an organic material that preferably has the form of a non-woven fleece. The organic material, which preferably contains a polymer and particularly preferably a polyethylene terephthalate (PET), is coated with an inorganic, preferably ion conducting material, that is more preferably ion-conductive in a temperature range from −40° C. to 200° C. The inorganic material preferably contains at least one compound from the group of oxides, phosphates, sulphates, titanates, silicates, aluminosilicates with at least one of the elements Zr, Al, Li, particularly preferably zirconium oxide. The inorganic ion conducting material preferably contains particles having a maximum diameter smaller than 100 nm. Such a separator is sold in Germany for example by Evonik AG under the commercial trade name “Separion”.

The method preferably includes the further step: preventing further discharge of electrical energy by the battery depending on the response received in the preceding step, if the decision not to carry out an exception operation has been reached by the decision unit.

The method preferably includes the further step: collecting usage parameter data of the battery.

For the purposes of the present invention, the term usage parameter data is to be understood to refer not only to a plurality of usage parameter data items, but possibly also to a single item of usage parameter data. Similarly for the purposes of the present invention, the term predefined usage parameter values is to be understood to refer not only to a plurality of predefined usage parameter values, but possibly also to a single predefined operating parameter value.

The method includes the further steps: determining whether the collected usage parameter data of the battery satisfy predefined usage conditions, and carrying out an exception operation of the battery if it has been determined in the preceding step that the collected usage parameter data of the battery satisfy the predefined usage conditions. One advantage of this configuration consists in that the decision regarding exception operation may be influenced according to the desired use of the battery, for example to bridge exception situations in the event of power failures.

The method preferably includes the further step: preventing further discharge of electrical energy by the battery if it has been determined in the preceding step that the collected usage parameter data of the battery do not satisfy the predefined usage conditions.

In the method, the step of determining whether the collected usage parameter data of the battery satisfy predefined usage conditions preferably includes at least one of the following determination steps: determining whether the collected usage parameter data include predefined first usage parameter values, determining whether the collected usage parameter data do not include predefined second usage parameter values, determining whether the collected usage parameter data exceed predefined third usage parameter values, determining whether the collected usage parameter data fall below pre-defined fourth usage parameter values, or determining whether the collected usage parameter data fall within a predefined usage parameter value range about a predefined fifth usage parameter value.

The method preferably includes the further step: transmitting the collected usage parameter values to the decision unit, wherein the step of determining a response to the query by the decision unit is performed at least partially on the basis of the transmitted usage parameter data.

The method preferably includes the further steps: determining whether the operating parameter data of the battery satisfy predefined emergency operation conditions, and preventing further discharge of electrical energy by the battery if it has been determined in the step of determining whether the collected operating parameter data of the battery satisfy predefined emergency operation conditions that the collected operating parameter data of the battery do not satisfy predefined emergency operation conditions.

One of the predefined exception operation conditions in the method preferably includes a battery voltage in a range from 1.5 V to 3.0 V, and particularly preferably a battery voltage of 2.7 V. For the systems that contain lithium iron phosphate (LFP), a battery volt-age of 1.8 V has proven particularly advantageous for the predefined exception operation condition. For the systems that contain lithium-cobalt-manganese-nickel systems (NMC), a battery voltage of 2.0 V has proven particularly advantageous for the predefined exception operation condition.

In the method, the step of determining whether the collected operating parameter data of the battery satisfy predefined emergency operation conditions preferably includes at least one of the following determination steps: determining whether the collected operating parameter data include predefined first emergency operation parameter values, determining whether the collected operating parameter data do not include predefined second emergency operation parameter values, determining whether the collected operation parameter data exceed predefined third emergency operation parameter values, determining whether the collected operation parameter data fall below predefined fourth emergency operation parameter values, or determining whether the collected operating parameter data fall within a predefined emergency operation parameter value range about a predefined fifth emergency operation parameter value.

In the method, the step of determining whether the collected operating parameter data of the battery satisfy predefined operation conditions preferably includes at least one of the following determination steps: determining whether the collected operating parameter data include predefined first operation parameter values, determining whether the collected operating parameter data do not include predefined second operation parameter values, determining whether the collected operation parameter data exceed predefined third operation parameter values, determining whether the collected operation parameter data fall below predefined fourth operation parameter values, or determining whether the collected operating parameter data fall within a predefined operation parameter value range about a predefined fifth operation parameter value.

The method preferably includes means that enable an operator of a motor vehicle to influence and/or make the decision in the step of determining a response via the decision unit.

The method preferably includes means that enable a provider of the battery to influence and/or make the decision in the step of determining a response via the decision unit.

According to a second aspect, this object is solved in a battery with a plurality of electrochemical cells, particularly a battery with a plurality of electrochemical cells that is configured for use in a motor vehicle, in that the battery has a control unit that is designed for operating the battery in a normal mode and an exception mode depending on the operating parameter data of the battery and a response from a decision unit. The battery with the control unit is preferably designed to carry out one of the methods described in the preceding.

In the following, aspects of the invention will be explained in greater detail with reference to preferred embodiments and with the aid of the drawing. In the drawing:

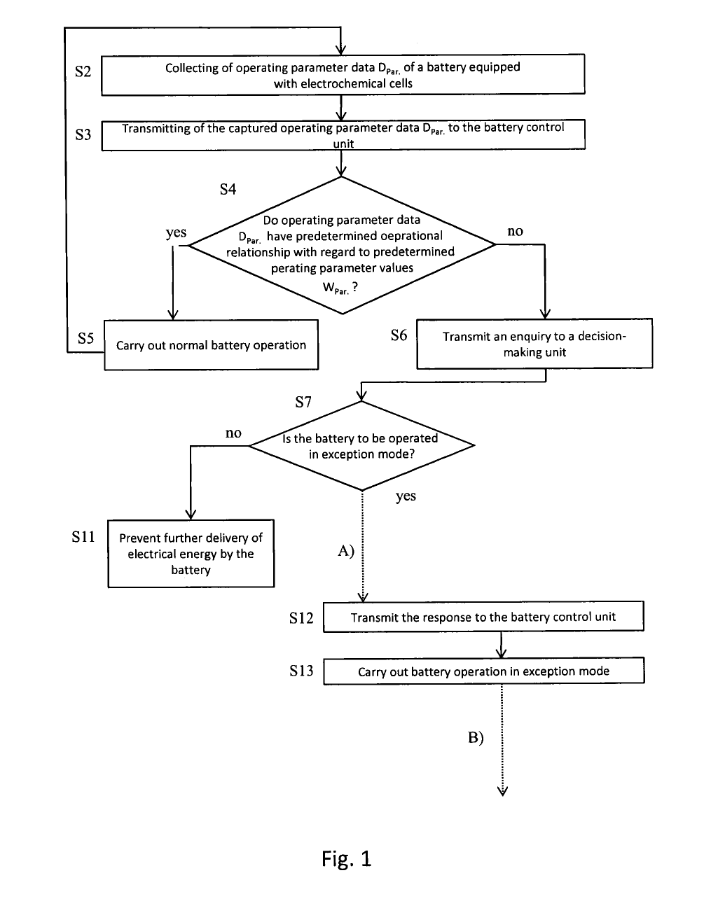

FIG. 1 is a flowchart of a method for operating a battery according to a first embodiment,

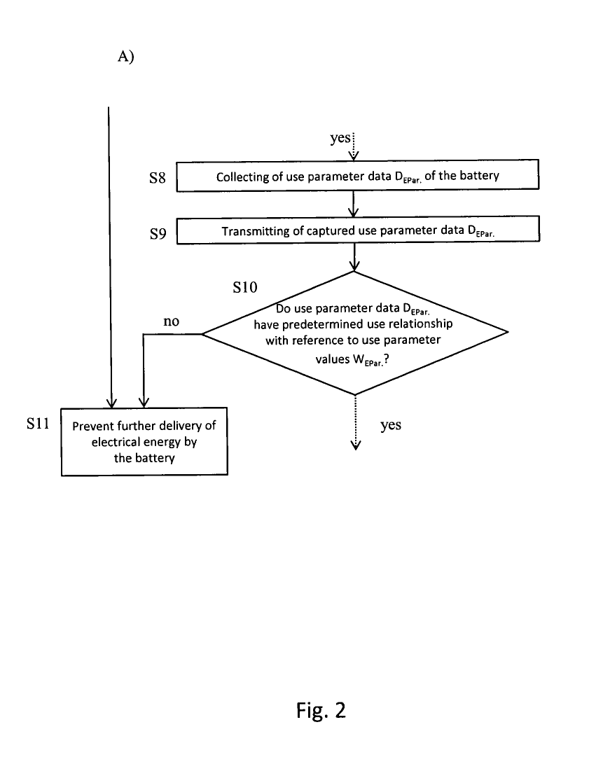

FIG. 2 is a detail view of a flowchart of a method for operating a battery according to a second embodiment,

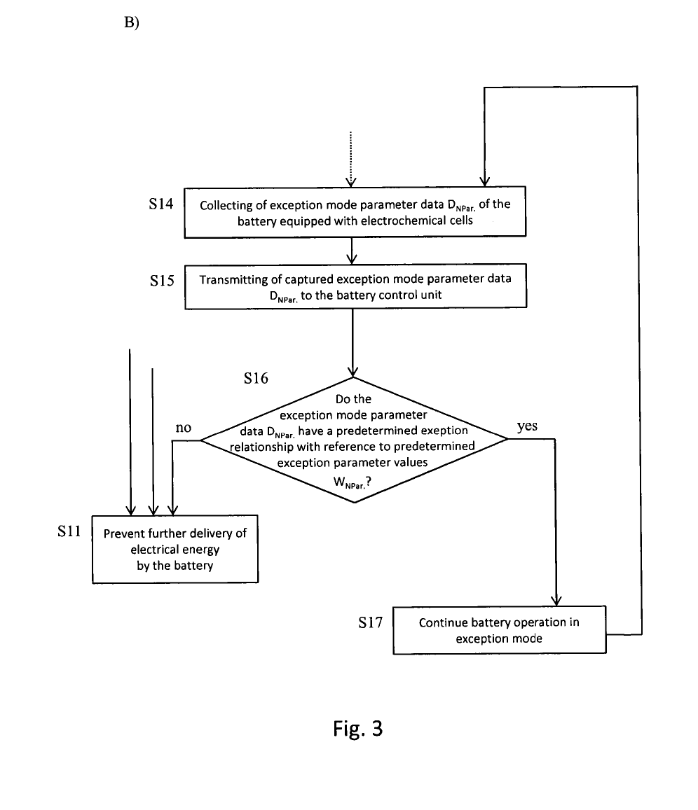

FIG. 3 is a detail view of a flowchart of a method for operating a battery according to third embodiment,

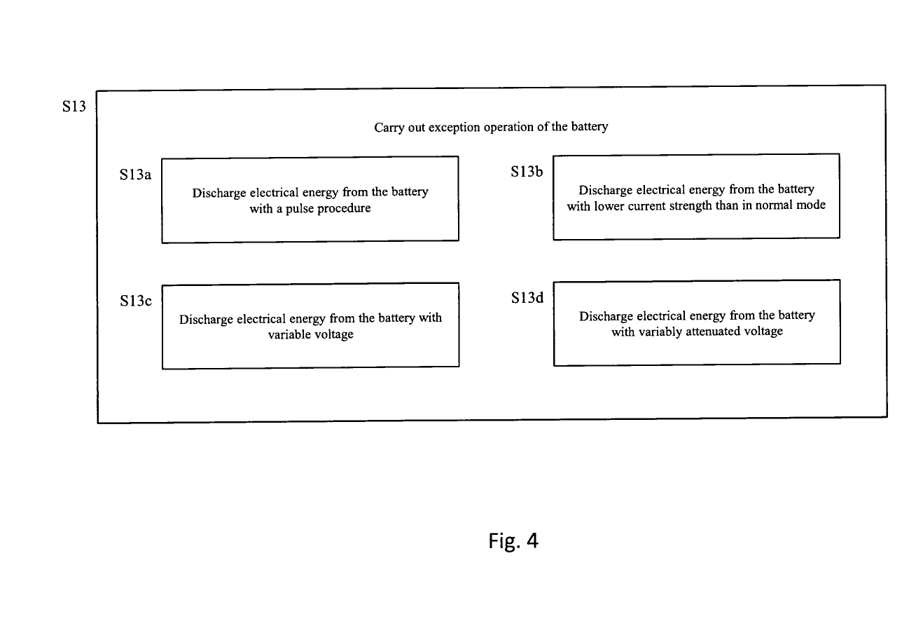

FIG. 4 is a representation of preferred steps in an exception operation of the battery,

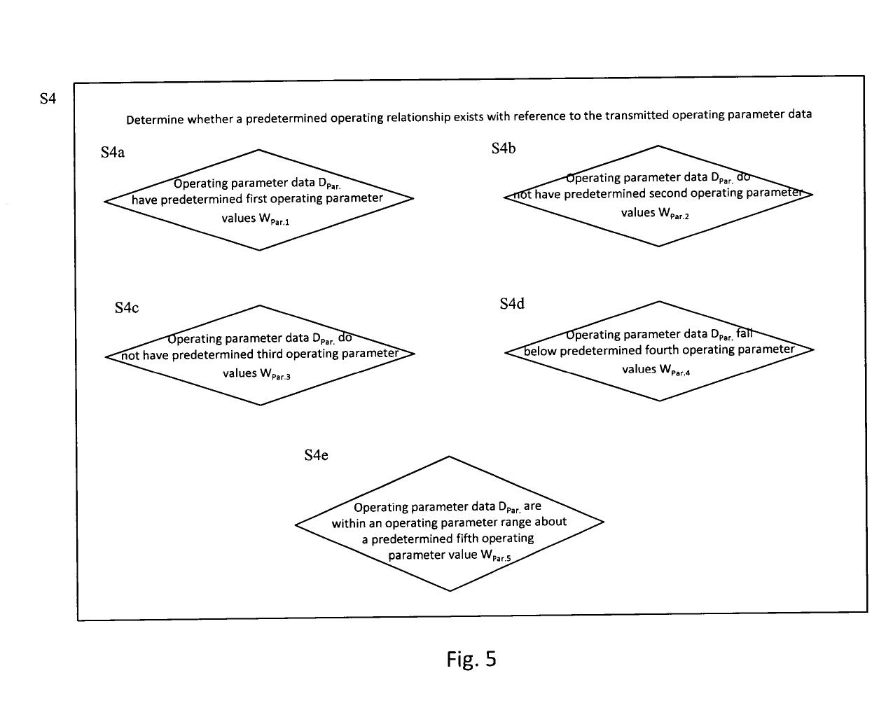

FIG. 5 is a representation of preferred steps in determining whether the operating parameter data satisfy a predefined operating condition,

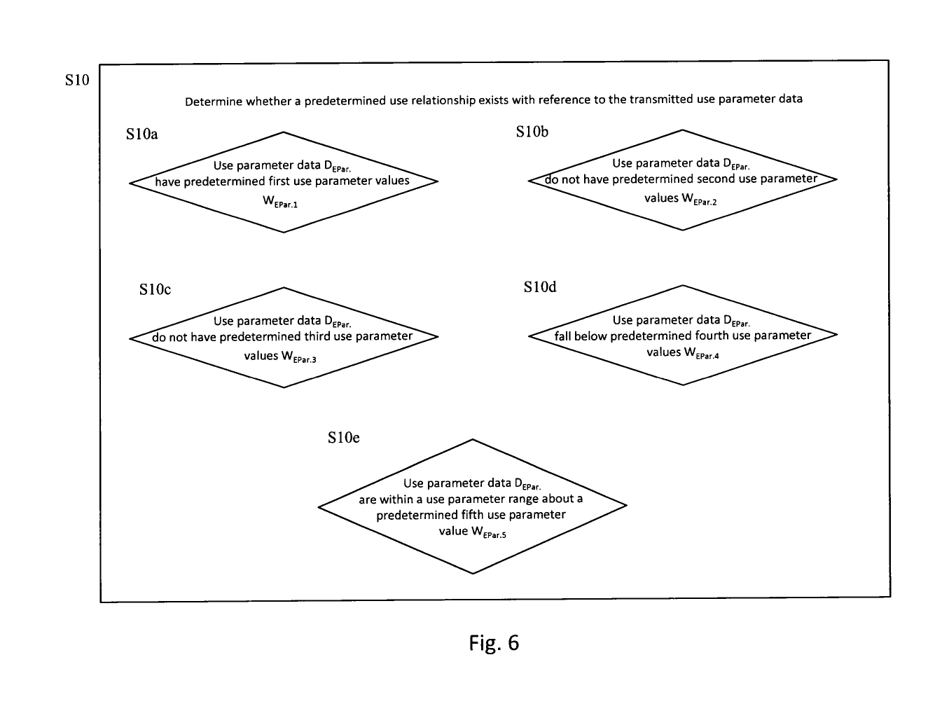

FIG. 6 is a representation of preferred steps in determining whether the usage parameter data satisfy a predefined operating condition, and

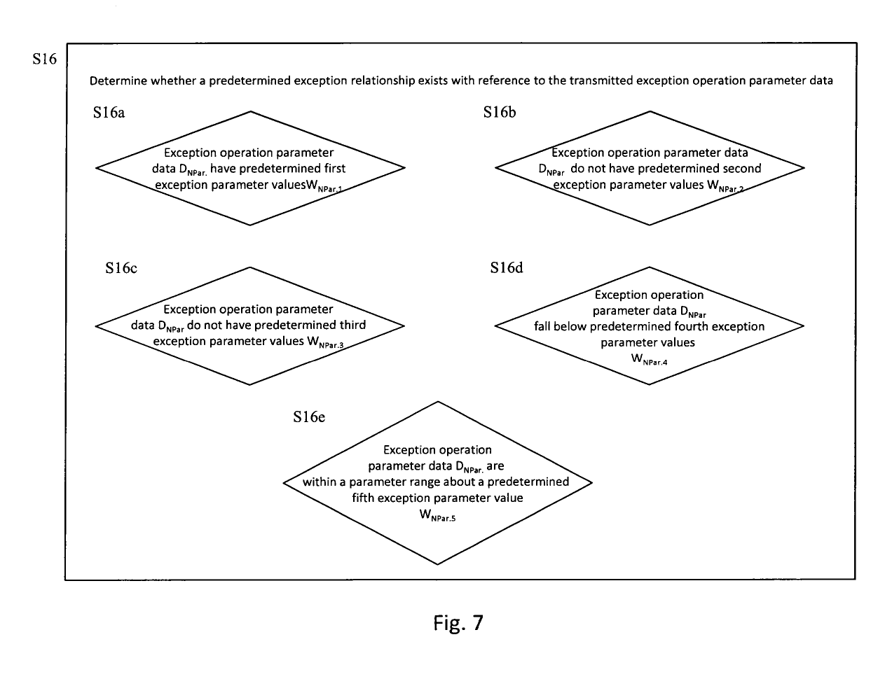

FIG. 7 is a representation of preferred steps in determining whether the exception operation parameter data satisfy a predefined exception operating condition.

FIG. 1 shows a flowchart of a method for operating a battery according to a first embodiment. In a step S2, operating parameter data D_{Par} of the battery are collected and in a step S3 the collected operating parameter data D_{Par} are transmitted to a control unit. In a step S4, it is determined whether the transmitted operating parameter data D_{Par} satisfy a predefined operating condition, particularly whether a predefined relationship exists between the transmitted operating parameter data D_{Par} and predefined operating parameter values W_{Par.1}, W_{Par.2}, W_{Par.3}, W_{Par.4}, W_{Par.5}. If the transmitted operating parameter data D_{Par} satisfy the predefined operating condition, normal operation of the battery continues in a step S5, and steps S2 to S4 may be repeated to check the operating parameters of the battery. On the other hand, if the transmitted operating parameter data D_{Par} do not satisfy the predefined operating condition, in a step S6 a query as to whether an exception operation of the battery is to be carried out is transmitted to a decision unit, via which in step S7 the decision is made as to whether the exception operation is to be carried out. According to a preferred embodiment, this query is displayed to the driver of the motor vehicle on a screen, and the driver is able to enter a decision regarding possibly carrying out an exception operation of the battery via an input device. According to another preferred embodiment, this query is transmitted, via a telecommunication connection for example, to a decision unit that is accessible to a rental organisation and/or owner of the battery, and in which the decision regarding an exception operation of the battery may be made automatically for example on the basis of stored technical data for the battery in question or on the basis of stored technical data for these battery types, or on the basis of a user agreement regarding this battery.

If it has been determined in step S7 that the exception operation of the battery is not to be carried out, in a step S11 the battery is prevented from discharging any more electrical energy. According to a preferred embodiment, this is achieved via an instruction that is sent by the decision unit to the battery control unit. According to another preferred embodiment, this is achieved by the fact that an instruction to enable the exception operation is not transmitted to the battery control unit.

If it has been determined in step S7 that the exception operation of the battery is to be carried out, the response is transmitted to the battery control unit in a step S12 and the exception operation of the battery is carried out in a step S13.

The partial sections identified by A) and B) in FIG. 1 relate to preferred embodiments, which will be described in greater detail in the following.

FIG. 2 is a detail view of the partial section identified with A) in FIG. 1 of a flowchart of a method for operating a battery according to a second embodiment. In this preferred second embodiment, if it has been determined in step S7 that the exception operation of the battery is to be carried out, usage parameter data D_{EPar} are collected in a step S8, and in a step S9 the collected usage parameter data D_{EPar} are transmitted to the control unit and/or the decision unit, so that in a step S10 it is determined in the control unit and/or the decision unit whether a predefined usage relationship exists between the collected usage parameter data D_{EPar} and predefined usage parameter values W_{EPar.1}, W_{EPar.2}, W_{EPar0.3}, W_{EPar.4}, W_{EPar.5}. If the collected usage parameter data D_{EPar} of the battery do not have the predefined usage relationship with the predefined usage parameter values W_{EPar.1}, W_{EPar.2}, W_{EPar.3}, W_{EPar.4}, W_{EPar.5}, in step S11, further discharge of electrical energy by the battery is prevented. If the collected usage parameter data D_{EPar} of the battery does have the predefined usage relationship with the predefined usage parameter values W_{EPar.1}, W_{EPar.2}, W_{EPar.3}, W_{EPar.4}, W_{EPar.5}, the method is continued with steps S12 and S13 shown in FIG. 1.

FIG. 3 is a detail view of the partial section identified with B) in FIG. 1 of a flowchart of a method for operating a battery according to a third embodiment. In this preferred third embodiment, if it has been determined in step S7 that the exception operation of the battery is to be carried out, exception operation parameter data D_{Npar} are collected in a step S14, and in a step S15 the collected exception operation parameter data D_{NPar} are transmitted to the control unit, so that in a step S16 it is determined in the control unit whether a predefined exception operation relationship exists between the collected exception operation parameter data D_{Npar} and the predefined exception operation parameter values W_{NPar.1}, W_{NPar.2}, W_{NPar.3}, W_{NPar.4} W_{NPar.5}. If the collected exception operation parameter data D_{NPar} of the battery do not have the predefined exception operation relationship with the predefined exception operation parameter values W_{NPar.1}, W_{NPar.2}, W_{NPar.3}, W_{NPar.4}, W_{NPar.5}, in step S11, further discharge of electrical energy by the battery is prevented. If the collected exception operation parameter data D_{NPar} of the battery does have the predefined except-ion operation relationship with the predefined exception operation parameter values W_{NPar.1}, W_{NPar.2}, W_{NPar.3}, W_{NPar.4}, W_{NPar.5}, the method is continued with the exception operation of the battery in step S18.

FIG. 4 shows a representation of preferred steps in an exception operation of the battery. As is shown in FIG. 4, step S13 of carrying out the exception operation of the battery may include a step S13a of discharging electrical energy from the battery in a pulse process, a step S13b of discharging electrical energy from the battery with a lower electrical current than in normal operation, a step S13c of discharging electrical energy from the battery with variable voltage, or a step S13d of discharging electrical energy from the battery with variably diminishing voltage.

FIG. 5 shows a representation of preferred embodiments for step S4 in determining whether the transmitted operating parameter data satisfy a predefined operating condition. In a step S4a, it may be determined via the control unit whether these operating parameter data D_{Par} include predefined first operating parameter values W_{Par.1}. If the operating parameter data D_{Par} include the predefined first operating parameter values W_{Par.1}, normal operation of the battery continues. Otherwise, if operating parameter data D_{Par} do not include the predefined first operating parameter values W_{Par.1}, the method is continued from step S6.

In a step S4b it may be determined via the control unit whether these operating parameter data D_{Par} do not include predefined second operating parameter values W_{Par.2}. If the operating parameter data D_{Par} do not include the predefined first operating parameter values W_{Par.2}, normal operation of the battery continues. Otherwise, if operating parameter data D_{Par} include the predefined second operating parameter values W_{Par.2} the method is continued from step S6.

In a step S4c it may be determined via the control unit whether these operating parameter data exceed predefined third operating parameter values W_{Par.3}. If the operating parameter data D_{Par} exceed the predefined third operating parameter values W_{Par.3}, normal operation of the battery continues. Otherwise, if operating parameter data D_{Par} do not exceed the predefined third operating parameter values W_{Par.3}, the method is continued from step S6.

In a step S4d it may be determined via the control unit whether these operating parameter data Dₚₐᵣ fall below predefined fourth operating parameter values W_{Par.4}. If the operating parameter data D_{Par} fall below the predefined fourth operating parameter values W_{Par.4}, normal operation of the battery continues. Otherwise, if operating parameter data D_{Par} do not fall below the predefined fourth operating parameter values W_{Par.4}, the method is continued from step S6.

In a step S4e it may be determined via the control unit whether these operating parameter data D_{Par} fall within a predefined operating parameter range about a predefined fifth operating parameter value W_{Par.5}. If the operating parameter data D_{Par} fall within the predefined operating parameter range about the predefined fifth operating parameter value W_{Par.5}, normal operation of the battery continues. Otherwise, if operating parameter data D_{Par} do not fall within the predefined operating parameter range about the predefined fifth operating parameter value W_{Par.5}, the method is continued from step S6.

FIG. 6 shows a representation of preferred embodiments of step S10 for determining whether a predefined relationship exists with reference to the transmitted usage parameter data D_{EPar}. In a step S10a, it may be determined via the control unit whether these usage parameter data D_{EPar} include predefined first usage parameter values W_{EPar.1}. If the usage parameter data D_{EPar} include the predefined first usage parameter values W_{EPar.1} the method is continued from step S12. Otherwise, if the usage parameter data D_{EPar} do not include the predefined first usage parameter values W_{EPar.1}, in step S11 the battery is prevented from discharging any more electrical energy.

In a step S10b, it may be determined via the control unit whether these usage parameter data D_{Epar} do not include predefined second usage parameter values W_{EPar.2}. If the usage parameter data D_{Epar} do not include the predefined second usage parameter values W_{EPar.2}, the method is continued from step S12. Otherwise, if the usage parameter data D_{Epar} do include the predefined second usage parameter values W_{EPar.2} in step S11 the battery is prevented from discharging any more electrical energy.

In a step S10c, it may be determined via the control unit whether these usage parameter data D_{Epar} exceed predefined third usage parameter values W_{EPar.3}. If the usage parameter data exceed the pre-defined third usage parameter D_{EPar} values W_{EPar.3} the method is continued from step S12. Otherwise, if the usage parameter data D_{Epar} do not exceed the predefined third usage parameter values W_{EPar.3}, in step S11 the battery is prevented from discharging any more electrical energy.

In a step S10d, it may be determined via the control unit whether these usage parameter data D_{Epar} fall below predefined fourth usage parameter values W_{EPar.4}. If the usage parameter data D_{EPar} fall below the pre-defined fourth usage parameter values W_{EPar.4}, the method is continued from step S12. Otherwise, if the usage parameter data D_{EPar} do not fall below the predefined fourth usage parameter values W_{EPar.4}, in step S11 the battery is prevented from discharging any more electrical energy.

In a step S10e, it may be determined via the control unit whether these usage parameter data D_{EPar} fall within a predefined usage parameter range about a predefined fifth usage parameter value W_{EPar.5}. If the usage parameter data D_{EPar} fall within a predefined usage parameter range about a predefined fifth usage parameter value W_{EPar.5}, the method is continued from step S12. Otherwise, if the usage parameter data D_{EPar} do not fall within a predefined usage parameter range about the predefined fifth usage parameter value W_{EPar.5}, in step S11 the battery is prevented from discharging any more electrical energy.

FIG. 7 shows a representation of preferred embodiments of step S16 for determining whether a predefined relationship exists with reference to the transmitted exception operation parameter data D_{Npar}. In a step S16a, it may be determined via the control unit whether these exception operation parameter data D_{NPar} include predefined first exception operation parameter values W_{NPar.1}. If the exception operation parameter data D_{Npar} include the predefined first exception operation parameter values W_{NPar.1}, the exception operation is continued in a step S17. Otherwise, if the exception operation parameter data D_{NPar} do not include the predefined first exception operation parameter values W_{NPar.1}, in step S11 the battery is prevented from discharging any more electrical energy.

In a step S16b, it may be determined via the control unit whether these exception operation parameter data D_{NPar} do not include predefined second exception operation parameter values W_{NPar.2}. If the exception operation parameter data D_{NPar} do not include the predefined second exception operation parameter values W_{NPar.2}, the exception operation is continued in a step S17. Otherwise, if the exception operation parameter data D_{NPar} do include the predefined second exception operation parameter values W_{NPar.2}, in step S11 the battery is prevented from discharging any more electrical energy.

In a step S16c, it may be determined via the control unit whether these exception operation parameter data D_{NPar} exceed predefined third exception operation parameter values W_{NPar.3}. If the exception operation parameter data D_{NPar} exceed the predefined third exception operation parameter values W_{NPar.3}, the exception operation is continued in a step S17. Otherwise, if the exception operation parameter data D_{NPar} do not exceed the predefined third exception operation parameter values W_{NPar.3}, in step S11 the battery is prevented from discharging any more electrical energy.

In a step S16d, it may be determined via the control unit whether these exception operation parameter data D_{NPar} fall below predefined fourth exception operation parameter values W_{NPar.4}. If the exception operation parameter data D_{NPar} fall below the predefined fourth exception operation parameter values W_{NPar.4} the exception operation is continued in a step S17. Otherwise, if the exception operation parameter data D_{Npar} do not fall below the predefined fourth exception operation parameter values W_{NPar.4}, in step S11 the battery is prevented from discharging any more electrical energy.

In a step S16e, it may be determined via the control unit whether these exception operation parameter data D_{NPar} fall within a predefined exception operation parameter range about a predefined fifth exception operation parameter value W_{NPar.5}. If the exception operation parameter data D_{NPar} fall within a predefined exception operation parameter range about a predefined fifth exception operation parameter value W_{NPar.5}, the exception operation of the battery is continued in a step S17. Otherwise, if the exception operation parameter data D_{Npar} do not fall within the predefined exception operation parameter range about the predefined fifth exception operation parameter value W_{NPar.5}, in step S11 the battery is prevented from discharging any more electrical energy.

### LEGEND

S2 Collecting operating parameter data of the battery
S3 Transmitting the operating parameter data to a control unit
S4 Determining whether the collected operating parameter data of the battery satisfy predefined operating conditions
S4a Determining whether the collected operating parameter data include predefined first operating parameter values
S4b Determining whether the collected operating parameter data do not include predefined second operating parameter values
S4c Determining whether the collected operating parameter data exceed predefined third operating parameter values
S4d Determining whether the collected operating parameter data fall below predefined fourth operating parameter values
S4e Determining whether the collected operating parameter data fall within a predefined operating parameter value range about a predefined fifth operating parameter value
S5 Carrying out normal operation of the battery if the collected operating parameter data of the battery satisfy the predefined operating conditions
S6 Transmitting a query to a decision unit
S7 Determining a response by the decision unit
S8 Collecting the usage parameter data of the battery
S9 Transmitting the collected usage parameter data to the decision unit and/or the control unit
S10 Determining whether the transmitted usage parameter data of the battery satisfy predefined usage conditions
S10a Determining whether the collected usage parameter data include predefined first usage parameter values
S10b Determining whether the collected usage parameter data do not include predefined second usage parameter values
S10c Determining whether the collected usage parameter data exceed predefined third usage parameter values
S10d Determining whether the collected usage parameter data fall below predefined fourth usage parameter values
S10e Determining whether the collected usage parameter data fall within a predefined usage parameter value range about a predefined fifth usage parameter value
S11 Preventing the battery from discharging further electrical energy
S12 Transmitting the response to the battery control unit
S13 Carrying out exception operation of the battery
S13a Discharging electrical energy from the battery by a pulse method
S13b Discharging electrical energy from the battery with a reduced current compared with normal operation
S13c Discharging electrical energy from the battery with variable voltage
S13d Discharging electrical energy from the battery with variably diminishing voltage
S14 Collecting exception operation parameter data of the battery
S15 Transmitting the collected exception operation parameter data to the battery control unit
S16 Determining whether the collected operating parameter data of the battery satisfy predefined exception operation conditions
S16a Determining whether the collected operating parameter data include predefined first exception operation parameter values
S16b Determining whether the collected operating parameter data do not include predefined second exception operation parameter values
S16c Determining whether the collected operating parameter data exceed predefined third exception operation parameter values
S16d Determining whether the collected operating parameter data fall below predefined fourth exception operation parameter values
S16e Determining whether the collected operating parameter data fall within a predefined exception operation parameter value range about a predefined fifth exception operation parameter value
S17 Continuing exception operation of the battery

1. A method for operating a battery comprising a plurality of electrochemical cells, particularly a battery designed for use in a motor vehicle, having a battery control unit, wherein the method includes the following steps:
(S2) collecting operating parameter data (D_{Par}) of the battery,
(S3) transmitting the operating parameter data (D_{Par}) to a control unit,
(S4) determining and checking by means of the control unit whether a predefined relationship exists between the operating parameter data (Dₚₐᵣ) and predefined operating parameter values (W_{Par.1}, W_{Par.2}, W_{Par.3}, W_{Par.4}, W_{Par.5}) and
(S5) carrying out normal operation of the battery if it has been determined in the preceding step (S4) that the predefined relationship exists between the collected operating parameter data (Dₚₐᵣ) of the battery and predefined operating parameter values (W_{Par.1}, W_{Par.2}, W_{Par.3}, W_{Par.4}, W_{Par.5}),
characterized in that if it is determined in step (S3) of determining and checking whether the collected operating parameter data (Dₚₐᵣ) of the battery satisfy predefined operating conditions, it has been determined that the predefined relationship between the collected operating parameter data (Dₚₐᵣ) of the battery with the predefined operating parameter values (W_{Par.1}, W_{Par.2}, W_{Par.3}, W_{Par.4}, W_{Par.5}) does not exist, the method comprises the following steps:
(S6) transmitting a query to a decision unit as to whether an exception operation of the battery is to be carried out,
(S7) determining a response to the query by the decision unit,
(S12) transmitting the response to the battery control unit,
(S13) carrying out exception operation of the battery depending on the response transmitted in the preceding step (S8), if it has been determined to carry out exception operation of the battery by the decision unit in the preceding step (S7).

2. The method according to claim 1, characterized in that step (S13) of carrying out exception operation of the battery at least partly includes one of the following steps for discharging energy from the battery:
(S13a) discharging electrical energy from the battery by a pulse method,
(S13b) discharging electrical energy from the battery with a reduced current compared with normal operation,
(S13c) discharging electrical energy from the battery with variable voltage, or
(S13d) discharging electrical energy from the battery with variably diminishing voltage.

3. The method according to claim 1 or 2, characterized in that one of the predefined operating condition values preferably includes a battery voltage in a range from 1.9 V to 4.5 V, preferably a battery voltage of 3.7 V, wherein the electrochemical cells of the battery have at least one electrode, preferably at least a cathode, that includes a compound with formula LiMPO₄, wherein M is at least one transition metal cation from the first row of the periodic table of elements, wherein this transition metal cation is preferably selected from the group including Mn, Fe, Ni and Ti or a combination of these elements, and wherein the compound preferably has an olivine structure, preferably superior olivine, wherein Fe is particularly preferred.

4. The method according to claim 3, characterized in that for the batteries whose electrodes contain lithium iron phosphate (LFP), a battery voltage in the range from 2.0 V to 3.65 V is selected for the predefined operating conditions, and/or that a battery voltage in the range from 2.5 V to 4.2 V is selected for the predefined operating conditions for the batteries whose electrodes contain lithium cobalt manganese nickel (NMC).

5. The method according to any of claims 1 to 4, characterized in that the method comprises the further step:
(S11) preventing the battery from discharging further electrical energy depending on the response received in step (S8), if it is has been decided by the decision unit not to carry out exception operation of the battery.

6. The method according to any of claims 1 to 5, characterized in that the method comprises the further steps:
(S8) collecting usage parameter data (D_{EPar}) of the battery and
(S9) transmitting the collected usage parameter data D_{EPar}) to the decision unit and/or the control unit.

7. The method according to claim 6, characterized in that the method comprises the further steps:
(S10) determining and checking whether a predefined usage relationship with reference to predefined usage parameter values W_{EPar.1}, W_{EPar.2}, W_{EPar.3}, W_{EPar.4}, W_{EPar.5}) exists for the collected usage parameter data (D_{EPar}), and
(S13) carrying out an exception operation of the battery if it has been determined in the preceding step (S10) that a predefined usage relationship with reference to predefined usage parameter values (W_{EPar.1}, W_{EPar.2}, W_{EPar.3}, W_{EPar.4}, W_{EPar.5}) exists for the collected usage parameter data (D_{Epar}).

8. The method according to claim 7, characterized in that the method comprises the further step:
(S11) preventing the battery from discharging further electrical energy if it has been determined in step (S5) that a predefined usage relationship with reference to predefined usage parameter values W_{EPar.1}, W_{EPar.2}, W_{EPar.3}, W_{EPar.4}, W_{EPar.5}) does not exist for the collected usage parameter data D_{EPar}).

9. The method according to any of claims 6 to 8, characterized in that step (S10) of determining and checking whether a predefined usage relationship with reference to the predefined usage parameter values (W_{EPar.1}, W_{EPar.2}, W_{EPar.3}, W_{EPar.4}, W_{EPar.5}) exists for the collected usage parameter data (D_{Epar}) of the battery comprises at least one of the following determination steps:
(S10a) determining and checking whether the collected usage parameter data (D_{Epar}) include predefined first usage parameter values (W_{ESwt.1}),
(S10b) determining and checking whether the collected usage parameter data (D_{EPar}) do not include predefined second usage parameter values (W_{ESwt.2}),
(S10c) determining and checking whether the collected usage parameter data (D_{EPar}) exceed predefined third usage parameter values (W_{ESwt.3}),
(S10d) determining and checking whether the collected usage parameter data (D_{EPar}) fall below predefined fourth usage parameter values (W_{ESwt.4})
(S10e) determining and checking whether the collected usage parameter data (D_{EPar}) fall within a predefined usage parameter value range about a predefined fifth usage parameter value (W_{ESwt.5}).

10. The method according to any of claims 6 to 9, characterized in that step (S8) of collecting usage parameter data (D_{EPar}) of the battery and step (S7) of transmitting the collected usage parameter data (D_{EPar}) to the decision unit are carried out before step (S7) of determining a response to the query by the decision unit, and that step (S7) of determining a response to the query by the decision unit is carried out at least partly on the basis of the transmitted usage parameter data (D_{Epar}).

11. The method according to any of claims 1 to 10, characterized in that the method comprises the further steps:
(S14) collecting exception operation parameter data (D_{Npar}) of the battery
(S15) transmitting the exception operation parameter data (D_{Npar}) to the control unit,
(S16) determining and checking by the control unit whether a predefined relationship of the exception operation parameter data (D_{NPar}) for the battery exists with reference to predefined exception operation parameter values (W_{NPar.1}, W_{NPar.2}, W_{NPar.3}, W_{NPar.4}, W_{NPar.5}), and
(S17) preventing discharge of electrical energy by the battery if in the preceding step (S17) of determining and checking whether a predefined relationship of the exception operation parameter data (D_{Npar}) for the battery exists with reference to predefined exception operation parameter values (W_{NPar.1}, W_{NPar.2}, W_{NPar.3}, W_{NPar.4}, W_{NPar.5}) it has been determined that the predefined relationship does not exist.

12. The method according to any of claims 1 to 11, characterized in that one of the predefined exception operation parameter values has a battery voltage in a range from 1.5 V to 3.0 V, preferably a battery voltage of 2.7 V, wherein the electrochemical cells include at least one electrode, preferably at least a cathode, that contains a lithium manganate, preferably LiMn₂O₄ of the spinel type, a lithium cobaltate, preferably LiCoO₂, or a lithium nickelate, preferably LiNiO₂, or a mixture of two or three of these oxides, or a lithium mixed oxide that contains manganese, cobalt and nickel.

13. The method according to claim 12, characterized in that for the batteries whose electrodes contain lithium iron phosphate (LFP), a battery voltage of 1.8 V is selected for the predefined exception operation parameter values, and/or that for the batteries whose electrodes contain lithium cobalt manganese nickel (NMC), a battery voltage of 2.0 V is selected for the predefined exception operation parameter values.

14. The method according to claim 11, 12 or 13, characterized in that step (S16) of determining and checking whether the collected exception operation parameter data of the battery satisfy predefined exception operation conditions includes at least one of the following determination steps:
(S16a) determining and checking whether the collected exception operation parameter data (D_{Npar}) include predefined first exception operation parameter values (W_{NSwt.1}),
(S16b) determining and checking whether the collected exception operation parameter data (D_{Npar}) do not include predefined second exception operation parameter values (W_{NSwt.2})
(S16c) determining and checking whether the collected exception operation parameter data (D_{Npar}) exceed predefined third exception operation parameter values (W_{NSwt.3}),
(S16d) determining and checking whether the collected exception operation parameter data (D_{Npar}) fall below predefined third exception operation parameter values (W_{NSwt.4}), or
(S16e) determining and checking whether the collected exception operation parameter data (D_{Npar}) fall within a predefined exception operation parameter value range about a predefined fifth exception operation parameter value (W_{NSwt.5}).

15. The method according to any of claims 1 to 14, characterized in that step (S4) of determining and checking whether the collected operating parameter data (Dₚₐᵣ) of the battery satisfy predefined operating conditions includes at least one of the following determination steps:
(S4a) determining and checking whether the collected operating parameter data (Dₚₐᵣ) include predefined first operation parameter values (W_{Swt.1}),
(S4b) determining and checking whether the collected operating parameter data (Dₚₐᵣ) do not include predefined second operation parameter values (W_{Swt.2}),
(S4c) determining and checking whether the collected operating parameter data (D_{Par}) exceed predefined third operating parameter values (W_{Swt.3}),
(S4d) determining and checking whether the collected operating parameter data (Dₚₐᵣ) fall below predefined fourth operating parameter values (W_{Swt.4}), or
(S4e) determining and checking whether the collected operating parameter data (D_{Par}) fall within a predefined operation parameter value range about a predefined fifth operating parameter value (W_{Swt.5}).

16. The method according to any of claims 1 to 15, characterized in that an operator of a motor vehicle is enabled to influence and/or make the decision for step (S7) of determining a response via the decision unit, and/or that a provider of the battery is enabled to influence and/or make the decision for step (S7) of determining a response via the decision unit.

17. A battery with a plurality of electrochemical cells, particularly a battery with a plurality of electrochemical cells that is configured for use in a motor vehicle, wherein the battery has a control unit that is designed for operating the battery in a normal mode and an exception mode depending on the operating parameter data (Dₚₐᵣ) of the battery and a response from a decision unit, characterized in that the battery with the control unit is designed to carry out a method according to any of claims 1 to 16.
